(19) United States
(12) Patent Application Publication
(10) Pub. No.: US 2024/0283641 A1
(43) Pub. Date: Aug. 22, 2024

(54) Systems, Methods, and Computer-Readable Media for Reprogrammable Authorization Key Generation Using NFC

(71) Applicant: Kevin McKeand Ecke, Boulder, CO (US)

(72) Inventor: Kevin McKeand Ecke, Boulder, CO (US)

(21) Appl. No.: 18/424,578

(22) Filed: Jan. 26, 2024

Related U.S. Application Data
(60) Provisional application No. 63/446,297, filed on Feb. 16, 2023.

(51) Int. Cl. H04L 9/08; H04L 9/00

(52) U.S. Cl. CPC H04L 9/0863; H04L 9/0877; H04L 9/50

(57) ABSTRACT

A key generation device for generating a private key includes a near field communication (NFC) tag configured to store a first key and a user device. The user device includes an input device configured to receive a first passcode from a user, a display screen configured to display information, a processor, and a memory including instructions stored thereon. The instructions, when executed by the processor, cause the user device to read the first key from the NFC tag and perform a first key derivation function or a first hashing algorithm based on the first key and the first passcode from the user to generate a private key. The private key is used to complete an operation that the user has intended to perform.

### CROSS-REFERENCE TO RELATED APPLICATIONS

This application claims the benefit of and priority to U.S. Provisional Patent Application Ser. No. 63/446,297 filed on Feb. 16, 2023, and entitled “Authorization Key Generation Apparatus and Methodology Using NFC,” which is expressly incorporated herein by reference in its entirety.

### FIELD

The present disclosure relates generally to systems, methods, and computer-readable mediums for generating authorization keys using a reprogrammable near field communication device and a passcode.

### BACKGROUND

Cryptocurrency wallets are the interface used to hold, store, and send cryptocurrency, digital assets, and other blockchain-based tokens. These wallets enable the convenient use of cryptographic asymmetric private keys on behalf of the user to authorize transactions on these networks. Such wallets are implemented either as a software wallet, in which the private keys used to authorize digital transactions are stored in memory accessible by the internet browser used by the owner, or a hardware wallet, in which the private keys are stored in the memory of the hardware device. Both of these implementations carry potential risks.

The private key of a software wallet is potentially remotely accessible to sophisticated computer hackers. The private key of a hardware wallet is potentially at risk due to loss of the device or mismanagement of the seed phrase recovery tools. These cryptocurrency wallets are required to interact with blockchain-based digital assets. This is because the private keys used to authorize crypto transactions are too long to be easily memorized and input by the owner of the digital assets when authorizing digital transactions. Therefore, cryptocurrency wallets were created to store these private keys and offer easily accessible transaction authorization to individuals participating in blockchain/cryptocurrency-based financial transactions. Both of these implementations store the private key within memory. This storage is a security shortcoming of these cryptocurrency wallets as sophisticated hackers may be able to retrieve the private key from the browser memory or from the hardware memory device and use them to fraudulently sign transactions on behalf of the true owner, thereby stealing all of the digital assets of the owner of these wallets.

Another shortcoming of these cryptocurrency wallets is that these wallets are often only accessible using one computer, one mobile device, or one hardware wallet. Thus, if an individual wants to sign a transaction, they must physically possess the computer, mobile device, or hardware wallet that stores their private key to authorize their transaction. If they need to use a different device, they must memorize or carry with them certain recovery information called a seed phrase to access their funds. These seed phrases effectively operate as master keys to all the assets ever associated with a person's wallet, and if a person inputs a seed phrase into another person's device it would be an enormous security breach that would threaten the security of their assets. This effectively means that the way wallets are currently built, it is not feasible for one person to access their assets on someone else's device. These seed phrases pose another shortcoming of cryptocurrency wallet implementations in themselves. A seed phrase is a collection of 12 to 24 words that represent a large complex number. This seed phrase is randomly generated every time a new wallet is created and operates as a master password recovery system for the wallet. The issue is that if this seed phrase is ever leaked to the internet in a hack or physically stolen, the person with this list of words has complete access to all of the assets and private keys for all of the accounts ever used by that wallet. If the seed phrase is ever lost or forgotten, the owner of the wallet will never be able to recover their digital assets from the wallets where they are stored. Therefore, the storage of this seed phrase poses a massive risk for individuals holding their assets.

Another shortcoming of these cryptocurrency wallets is that, in many cases, individuals who want to buy, trade, and hold cryptocurrency are tempted to buy these cryptocurrencies and store them on centralized exchanges because the hassle and risk of using their own software or hardware wallet keeps them away from self-custody. These centralized exchanges are companies like Coinbase, FTX, and Binance. These companies offer a slick user interface intended to make it simple to buy and hold cryptocurrency or digital assets for people just starting out in cryptocurrency trading. However, using one of these companies means giving control of the private keys that authorize their transactions to the company that operates this service. There have been several instances where fraudulent companies, poorly built products, or bankruptcy has resulted in the loss of user's assets. This is due to the centralized exchanges either having lost their users' funds, stolen funds from their users, or used their user's funds for extremely risky investment bets without the user's knowledge. As such, it is much more ideal that individuals are in control of the authorizing private keys that control their digital assets to avoid fraud and poorly built storage solutions. Therefore, it is desirable to have an interface for digital asset owners to be able to access their funds without memorizing prohibitively long numbers, risking exposure of their master password to their entire account, storing authorization keys in digital memory that may be leaked or hacked, being restricted to one device to make transactions, storing or remembering seed phrases that risk the loss of their entire digital asset portfolio, and ensuring that the individual owner is in direct control of their private keys that authorize their transactions.

These shortcomings are present not only in blockchain related areas but also in financial (e.g., credit card) transactions, personal/business web email accounts, personal/business health-related accounts with access to sensitive information, or any other security related accounts connected to computer networks in any way. IDs and respective passwords that are stored in any form of memory risk exposure to sophisticated computer hackers. And nowadays, even non-sophisticated computer hackers may be able to hack these IDs, passwords, or private keys by using artificial intelligence or machine learning algorithms without prior knowledge of sophisticated hacking techniques.

Accordingly, there is a need for improved security solutions to prevent potential hackers from accessing personal, sensitive, financial, transactional, or health-related information.

The subject matter claimed herein is not limited to aspects that solve any disadvantages or that operate only in environments such as those described above. Rather, this background is only provided to illustrate one exemplary technology area where some aspects described herein may be practiced.

### BRIEF SUMMARY

The present disclosure is related to systems, methods, and computer readable media for generating an authorization key and its associated public key using a near field communication (NFC) device and a passcode from a user. Thus, the authorization key does not have to be saved in a user's device including a mobile device, an NFC tag, or any other computing devices.

One aspect illustrated herein includes a key generation device which generates a private key. The key generation device includes a near field communication (NFC) tag configured to store a first key, and a user device. The user device includes an input device configured to receive a first passcode from a user, a display screen configured to display information, a processor, and a memory including instructions stored thereon. The instructions, when executed by the processor, cause the user device to read the first key from the NFC tag and perform a first key derivation function or a first hashing algorithm based on the first key and the first passcode from the user to generate a private key. The private key is used to complete an operation that the user has intended to perform.

Another aspect illustrated herein includes a key generation system which generates a plurality of private keys. The key generation device includes a near field communication (NFC) tag configured to store a first key, and a user device. The user device includes an input device configured to receive a first passcode from a user, a display screen configured to display information, a processor, and a memory including instructions stored thereon. The instructions, when executed by the processor, cause the user device to read a first key from a near field communication (NFC) tag, perform a first key derivation function or a first hashing algorithm based on the first key and the passcode from the user to generate a first private key, receive a combination of an order of and a number of entries of one or more user-selected passcodes and a motion of bringing the NFC tag in proximity to the user device, and generate a plurality of second private keys based on combinations of an order of and a number of entries of one or more user-selected passcodes and the motion. Each of the plurality of second private keys is to complete a respective operation that the user has intended to perform.

Still another aspect illustrated herein includes a non-transitory computer-readable medium including instructions stored thereon that, when executed by a computer, cause the computer to perform a method for generating a plurality of private keys. The method includes reading a first key from a near field communication (NFC) tag, performing a first key derivation function or a first hashing algorithm based on the first key and the passcode from the user to generate a first private key, receiving a combination of an order of and a number of entries of a passcode and a motion of bringing the NFC tag in proximity to the user device, and generating a plurality of second private keys based on combinations. Each of the plurality of second private keys is to complete a respective operation that the user has intended to perform.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific aspects which are illustrated in the appended drawings. Understanding that these drawings depict only typical aspects and are not therefore to be considered to be limiting in scope, aspects will be described and explained with additional specificity and detail through the use of the accompanying drawings in which:

FIG. 1 illustrates a block diagram of an authorization key generation device for electronic messages and transactions in accordance with aspects of the present disclosure;

FIG. 2A illustrates a flow diagram for writing a random value in a Near Field Communication (NFC) tag in accordance with aspects of the present disclosure;

FIG. 2B illustrates a flow diagram for an authorization key generation system in accordance with aspects of the present disclosure;

FIG. 2C illustrates a flow diagram for an authorization key generation system in accordance with aspects of the present disclosure;

FIG. 2D illustrates a flow diagram for an authorization key generation system in accordance with aspects of the present disclosure; and

FIG. 3 illustrates a state diagram for generating a private key in accordance with aspects of the present disclosure.

### DETAILED DESCRIPTION

The present disclosure is related to systems, methods, and computer readable media for generating an authorization key using a near field communication (NFC) device and a passcode from a user. Thus, the authorization key does not have to be saved in a user's device including a mobile device, an NFC tag, or any other computing devices, thereby preventing potential hackers from accessing one or more authorization keys for blockchain accounts, software or hardware (hot or cold) wallets, web accounts, or any other personal, financial, health-related, secure information.

Particularly, the authorization key is not saved in any devices and may be generated only when needed to complete a financial transaction, to access hot/cold wallets, web accounts, or any other sensitive information. Since one or more key derivation functions or hashing algorithms are used in generating the authorization key, small differences in input data to the key derivation functions or hashing algorithms result in a key substantially different from the intended authorization key. Thus, the present disclosure provides preventative measures to the potential hackings including key hijacking.

The following discussion now refers to a number of devices, which includes computing devices and NFC tags. Although NFC communications may be used in generating the authorization key, other types of communication protocol (e.g., Bluetooth, WiFi, satellite, cellular, Zigbee, infrared, RFID, microwave, wireless LAN, radio frequency communication, or etc.) may be also utilized in this disclosure.

The following discussion also refers to a number of methods, and method acts that may be performed. Although the method acts may be discussed in a certain order or illustrated in flow diagrams as occurring in a particular order, no particular ordering is required unless specifically stated, or required because an act is dependent on another act being completed prior to the act being performed.

Further, the methods may be practiced by a computer system including one or more processors and computer-readable media such as computer memory. In particular, the computer memory may store computer-executable instructions that when executed by one or more processors cause various functions to be performed, such as the acts recited in the aspects. According to other aspects, the computer systems may be embedded systems, for example, mobile devices, wearable devices, or system-on-chip (SoC) devices.

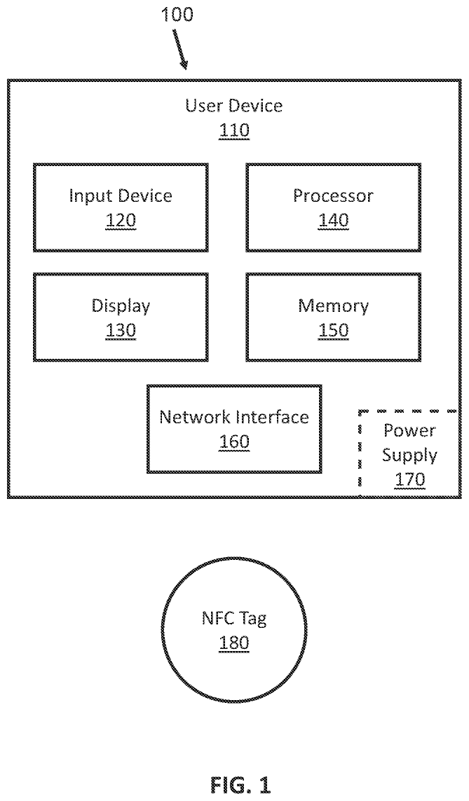

Referring now to FIG. 1, illustrated is a block diagram for an authorization key generation device 100 according to aspects of the present disclosure. The authorization key generation device 100 may generate an authorization key to complete an operation which a user intends to perform. The intended operation may include financial transactions, securities transactions, data transactions, and an access to blockchain accounts, cryptocurrency wallets, email accounts, financial websites, health-related information, personal information (e.g., trusts, wills, etc.), or any other information. In an aspect, one or more of the authorization keys may be combined to do the intended operation. For example, to access a user's will, the authorization key from the user and another authorization key from the user's attorney may be needed to access the user's will. Since only one of the authorization keys cannot access the user's will, security is improved.

Likewise, a portion of the authorization keys from among a group of the authorization keys may be needed to access sensitive information or make an important transaction by using Shamir secret sharing algorithm. In this case, a portion of a plurality of users' authorization keys is needed. It is noted that everyone's authorization key is different from each other.

The authorization key generation device 100 may include a user device 110 and an NFC tag 180. Neither of the user device 110 and the NFC tag 180 store an authorization key therein. Rather, the NFC tag 180 stores a first key, which may be a randomly generated value, a password, or one or more phrases. The first key may be used by the user device 110 to generate the authorization key. The first key may be independent of the authorization key. In an aspect, the NFC tag 180 may be integrated or embedded into any object, such as a ring, jewelry, wallet, key chain, smart watch, smartcard, glasses, pet's tag, or any other items which can hold the NFC tag 180 or in or on which the NFC tag 180 may be printed.

In a case of credit card transaction, when the credit card is scanned or touches a point of sale (POS) device, the card information such as the cardholder's full name, the credit card number, the expiration date, and/or a validation code are transmitted to the POS device. In fact, the credit card holds such information therein. Thus, sophisticated hackers may be able to access such information. Unlike conventional credit cards, no such information is stored in the user device 110 and the NFC tag 180. Even if hackers are able to access the first key from the NFC tag 180 and information from the user device 110, they cannot derive the authorization key. Thereby, the level of security in protecting the authorization key is improved.

The user device 110 may include an input device 120, a display 130, a processor 140, a memory 150, and a network interface 160. The user device 110 may communicate with the NFC tag 180 via the network interface 160. Specifically, the user device 110 may be able to read data from the NFC tag 180 and write data to the NFC tag 180. The communication may be performed only through the NFC protocol. In an aspect, the communication may be performed through but is not limited to the NFC protocol. The communication may be performed by employing Bluetooth, WiFi, satellite, cellular, Zigbee, infrared, RFID, microwave, wireless LAN, radio frequency communication, or any other communication protocol readily appreciated by persons having skill in the art.

In an aspect, a mobile device, embedded system, or computer (hereinafter collectively or individually “computer”) may generate a series of numbers or alphanumerals (such as credit card numbers, wallet addresses, or the first key) and write the series of numbers or alphanumerals (hereinafter the “first key”) to the NFC tag 180. When writing the first key, the computer may need a password to enable the writing functionality to the NFC tag 180. For example, only after the computer transmits the password to the NFC tag 180, the computer may be able to write, overwrite, remove, or change the first key stored in the NFC tag 180. Thus, the first key saved in the NFC tag 180 is immutable or locked without the password to the NFC tag 180. The first key may be predetermined by the user of the user device 110. Since the first key saved in the NFC tag 180 can be overwritten while NFC tag 180 is not password protected, the NFC tag 180 is reprogrammable to be reusable to generate other keys if the user so chooses.

The display 130 may display instructions or information to the user. For example, when the user needs to enter a passcode, such as a pin number, a password, or one or more phrases, via the input device 120, the display 130 displays instructions to instruct the user to enter the passcode. When the passcode is incorrect, the display 130 may display a notification of the incorrect passcode. The display 130 may be LCD, LED, or any other display.

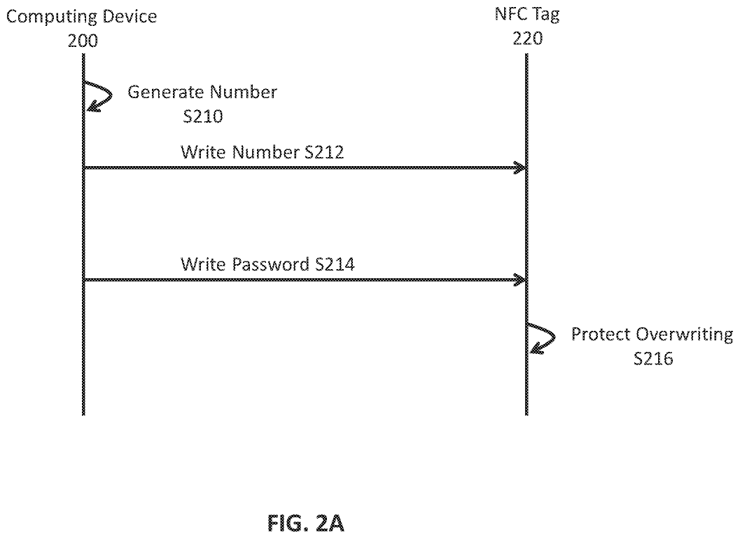

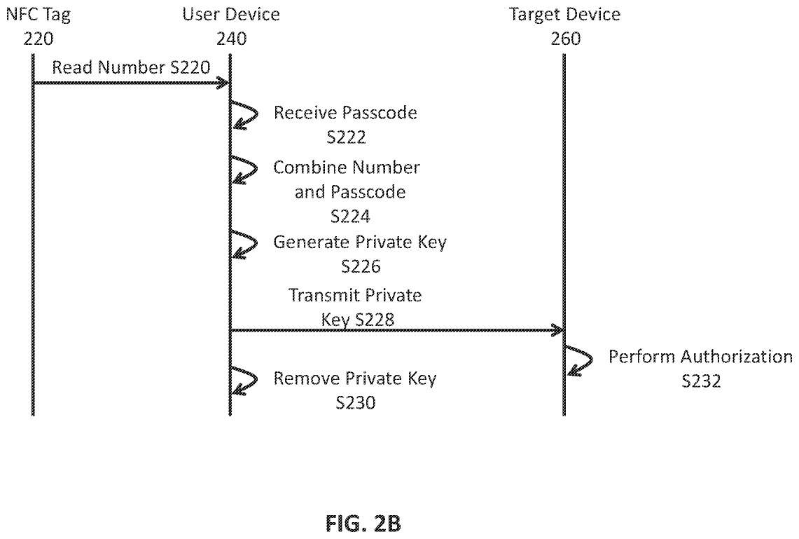

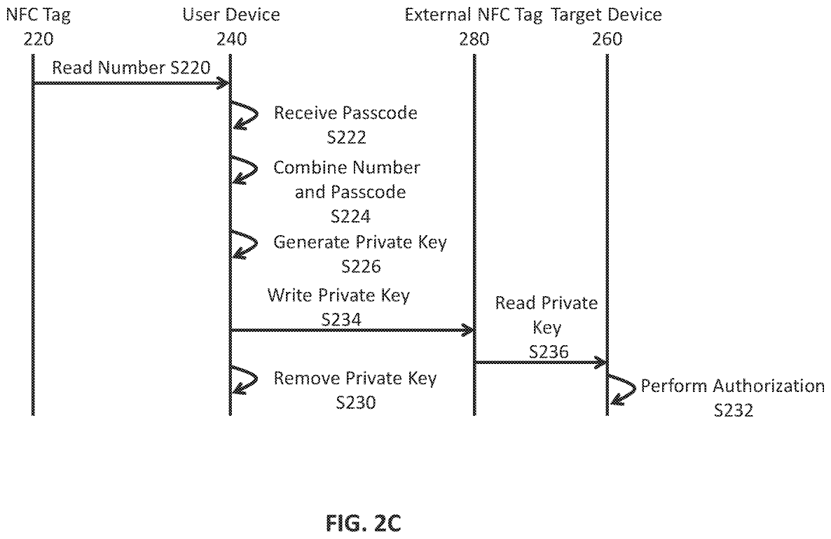

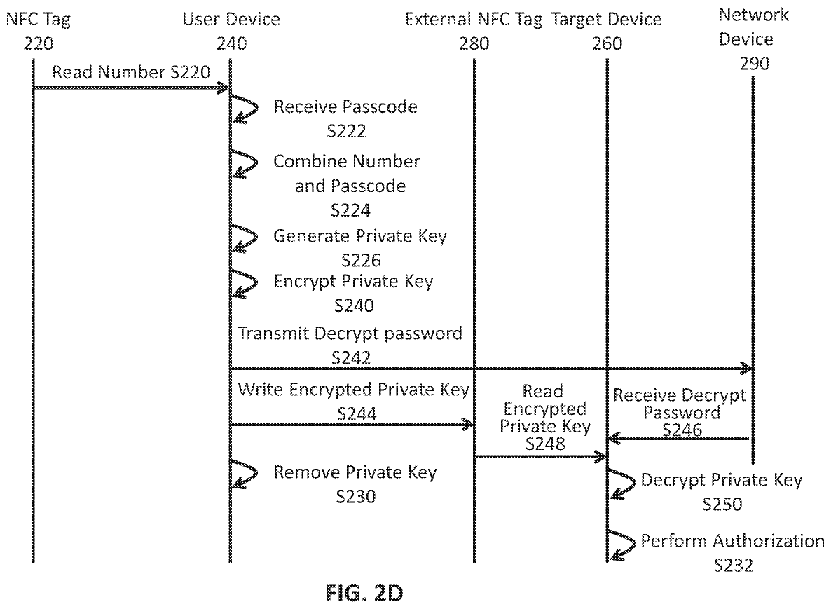

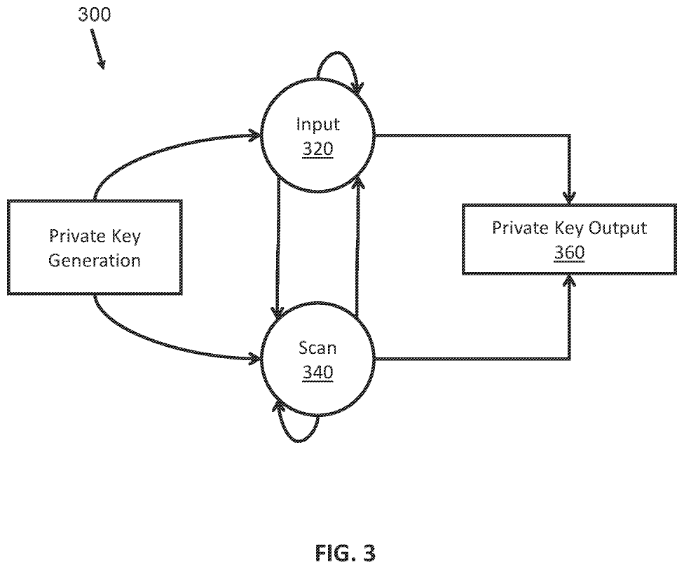

The memory 150 may include one or more executable instructions, programs, or algorithms. The processor 140 may execute the programs or algorithms. In some aspects, the executable instructions are executable by the processor 140 of the user device 110 to perform the disclosed operations, such as various methods of steps described below with reference to FIGS. 2A-2D and 3.

The input device 120 may be a keyboard, keypad, mouse, touchpad, touch screen, or any other input allowing device. Through the input device 120, a user of the user device 110 may be able to enter or input one or more numerals, alphabets, alphanumerals, or phrases, which may be referred to as a passcode hereinafter.

Through the network interface 160, data may be communicated with the user device 110. In this disclosure, the network interface 160 may be used to read data stored in the NFC tag 180 and rewrite data to the NFC tag 180. After reading the first key and receiving the passcode from the user, the processor 140 may combine, concatenate, utilize them to generate the authorization key. The passcode may be predetermined by the user and used together with the first key.

After generating the authorization key, the user device 110 may transmit the authorization key to a third party device to complete an intended operation. For example, when the intended operation is a purchase with a credit card, the third party device may be a point of sale (POS) device, and the authorization key may be credit card information. In a case when the intended operation is a login to a blockchain account, the third party device may be a web browser of a computer, terminal, or smart device, and the authorization key may be a private key paired with a public key, which is associated with the blockchain account. In another case where the intended operation is a login to an email, health, finance, or any other account, the third party device may be a web browser of a computer and the authorization key may be a password to the account.

In aspects, the authorization key may be a part of necessary information to perform the intended operation. As described above, when the intended operation is to access the user's will, the user's the authorization key together with an attorney's the authorization key are provided to the keeper of the will. When both the authorization keys match with the necessary information, the user and the attorney may be able to access the will, or approve a financial or securities transaction.

In another aspect, when both the authorization keys are received from the attorney and the user device 110, another the authorization key may be generated by executing another key derivation/hashing algorithm based on both the authorization keys. This another the authorization key may be the necessary information to access the will.

In still another aspect, the authorization key may be a part or share of secret or private information. According to Shamir's secret sharing, a sufficient number of shares or the authorization keys are needed to access the secret or private information. Thus, even if one of the authorization keys are acquired by hackers, they cannot access the secret or private information because one the authorization key is not sufficient to do such.

The processor 140 may use a key derivation/hashing algorithm based on the combination of the first key and the passcode. The key derivation/hashing algorithm generates a significantly different output with a small difference in the input value, which is the combination of the first key and the passcode. Due to this characteristic, even if potential eavesdroppers may be able to capture substantial portions of the passcode and acquire the NFC tag 180 and the user device 110, they are unable to generate the authorization key and perform the necessary order of operations without the whole of the passcode.

The user device 110 may include a power supply 170, which receives power from an external power outlet via a power cable. In an aspect, the power supply 170 may be a battery or renewable power generator (e.g., solar panel, etc.). The power supply 170 supplies power to every element of the user device 110 so that each element is able to perform its own functions.

In aspects, the user device 110 may have a size of a credit card. Thus, a substantial amount of power is not needed to perform operations in the user device 110.

In aspects, the user device 110 may include an adaptor portion (e.g., a serial port, parallel port, USB port, PS/2 port, VGA port, Fire Wire port, Infrared port, DVI port, Ethernet port, etc.), which is not shown in FIG. 1, to communicate with other external devices. Through the adaptor portion or the network interface 160, the programs, algorithms, codes saved in the memory 150 may be updated, renewed, added, changed, and removed.

Now referring to FIG. 2A, illustrated are steps for writing a key to an NFC tag 220 according to aspects of the present disclosure. An embedded device, mobile device, computing device, or computer 200 (hereinafter the “computer 200”) is communicatively coupled with the NFC tag 220. The computer 200 may be a special computer, which generates a special number (e.g., a credit card number, a specifically formatted number, a first key as described with respect to FIG. 1, or the likes) by following a rule or the user's instructions. For example, a credit card number is a special number generated by following a rule, which includes a number identifying the issuer. The number may be generated based on the user's selection by the computer 200 or randomly generated at step S210.

The computer 200 may make a communication channel with the NFC tag 220 by following the NFC protocol, which works in the range of 0.2 meters with a data transfer rate of 424 Kbit/s. The NFC protocol has a relatively short range and a low data transfer rate compared to Bluetooth, which has a range of 100 meters and a data transfer rate of 3 Mbit/s, infrared, which has a range of 1 meter and a data transfer rate of 3 Mbit/s, and WiFi, which has a range of 100 meters and 54 Mbit/s. Due to the short range, a potential hacker needs to be within the range of 0.2 meters. Thus, when a hacking occurs, the potential hacker may be easily identified.

Specifically, the computer 200 transmits radio waves to trigger and activate the antenna in the NFC tag 220. Once the computer 200 completes the validation, an exchange of information occurs. The NFC tag 220 is not run by power but may draw power from devices like smartphones. The basic structure of the NFC tag 220 may be the same as radio frequency identification (RFID) tags. After the NFC tag 220 is validated, the computer device 200 writes the number to the NFC tag 220 at step S212.

To prevent overwriting the number, the computer 200 may also transmit/write a password to the NFC tag 220 at step S214. Thus, without the password, a third party device cannot overwrite the number or data saved in the NFC tag 220. In an aspect, the number may be encrypted by the computer 200 and the encrypted number may be written to the NFC tag 220. In this way, a third party device may be able to read the encrypted number but unable to decrypt the encrypted number without a predetermined password, key, or decryption algorithm. The list of ways to prevent overwriting is provided as examples and may include other ways as readily appreciated by persons having skill in the art.

In consideration of the authorization key, as the final output, the number saved in the NFC tag 220 can be singly used to derive the authorization key, if the user decides that way, or cannot be singly used to derive the authorization key. On the other hand, the authorization key, however, cannot be derived without the number saved in the NFC tag 220. Thus, the number saved in the NFC tag 220 increases the level or security in areas described in this disclosure.

Now referring to FIG. 2B, illustrated steps for authorization according to aspects of the present disclosure. In these aspects, a user uses a user device 240 together with the NFC tag 220 to be authorized by a target device 260. The target device 260 may be a POS device, the same user device, a mobile smart phone, a cryptocurrency wallet whether hot or cold, a blockchain website, a blockchain node, a server, a blockchain network, an email account, a bank website, or any other institution, network, or information requiring a certain level of security. In this regard, the target device 260 requires an authorization key (e.g., a password or pass phrases) or a private key paired with a public key, which is saved in the target device 260.

For example, to access a cryptocurrency wallet, the public key may be an address of the cryptocurrency wallet and the private key is used to sign digital transactions or to prove that you are the true owner of the cryptocurrency. In another example, to access a bank website, the authorization key may be a password to log in to the bank website to access account information.

Now referring back to FIG. 2B, at step S220, the user device 240 reads the number saved in the NFC tag 220, which may be referred to as first key below. After the first key is obtained, the user device 240 requests the user to enter a passcode, which may be a pin number, a password, or any combination of numbers and phrases. The first key and the passcode may be combined at step S224. The combination may be performed by concatenating the first key and the passcode and/or appending a predetermined data to the combination of the first key and the passcode.

For example, where the first key is “helloworld,” the passcode is “27,” and the predetermined data is “1223456789,” during the combination, “helloworld”+“123456789”+“27”+“123456789” may be generated by combining and appending operations at step S224. The combining operation may be performed in any other ways to generate an output based on the first key and the passcode. Any alternation in the order, the passcode, and/or the predetermined data may yield an entirely different output or new key pair.

At step S226, the user device 240 generates a private key, as the authorization key, based on the output from the step S224. A key derivation algorithm or a hashing algorithm may be used to generate the private key. When the private key is used to make a commercial transaction, the private key may include any financial credential information required to complete the transaction.

In an aspect, when the private key is generated, the private key may be encrypted with a password to increase the level of security. The encrypted private key and the decryption password may be saved in different places or folders in the memory of the user device 240. Thus, before transmission, the private key is maintained as being encrypted, and at the time when the private key needs to be transmitted, the encrypted private key may be decrypted with the decryption password and transmitted to the target device 260 at step S228.

At step S228, the private key is transmitted to the target device 260 from the NFC tag 220. In an aspect, the user device 240 may have a credit card shape and transmission of the private key may be performed by following the NFC protocol. In other words, the user device 240 may include an NFC circuit and transmit the private key by tapping the target device 260 or placing the user device 240 in an NFC range from the target device 260.

The target device 260 then authenticates the user device 240 based on the private key at step 232. In order to increase the level of security, the user device may delete or remove the private key at 230 in a predetermined period after generating the private key at step S230. The predetermined period may be 30 seconds, 1 minute, 2 minutes, or less than 5 minutes. This list of predetermined periods is provided as example and can include other smaller or larger periods than in the list depending on the characteristics of the purpose of the authentication. If the purpose is a credit card transaction, the predetermined period may be less than 30 seconds. In a case where the authentication is performed more than once, the predetermined period may be longer than 5 minutes.

In an aspect, after generating the private key at step S226, the user device 240 may not transmit the private key to the target device 260. Instead, the user device 240 may perform the authentication at step S232, remove the private key at step S230, and transmit the authentication to the target device 260.

FIG. 2C illustrates another example of authentication according to aspects of the present disclosure. In addition to the authorization key generation as illustrated in FIG. 2B, an external NFC tag 280 is employed. Descriptions for steps S220-S226, S230, and S232 are the same as those described above with regard to FIG. 2B and thus are omitted here.

After generating the private key at step S226, the user device 240 writes the private key to the external NFC tag 280 at step S234. Since the private key is written to the external NFC tag 280, the user device 240 does not have to hold it for the predetermined period. Thus, the private key is removed from the user device 240 right after the private key is transferred to the external NFC tag 280. In this example, the external NFC tag 280 keeps the private key as long as needed by the target device 260. For example, when more than one authentication is required by the target device 260, the external NFC tag 280 may be used as long as required.

In an aspect, when the private key is generated, the private key may be encrypted with a password to increase the level of security. The encrypted private key and the decryption password may be saved in different places or folders in the memory of the user device 240. Thus, before transmission, the private key is maintained as being encrypted, and at the time when the private key needs to be transmitted, the encrypted private key may be decrypted with the decryption password and transmitted to the target device 260 at step S234.

At step S236, the target device 260 reads the private key from the external NFC tag 280 by following the NFC protocol. Further, at step S232, the user device 240 is authenticated by the target device 260 after the target device 260 confirms the mathematical relationship between the private key from the external NFC tag 280 and the public key saved in the target device 260.

After the authentication is confirmed, the user device 240 may communicate with the external NFC tag 280 and remove the private key from the external NFC tag 280. A password may be required to update or remove the private key from the external NFC tag 280.

By removing the private key from the user device 240 right after writing the private key to the external NFC tag 280 and also removing the private key from the external NFC tag 280, the chance of the private key being exposed to a third party device has been decreased substantially, thereby the level of security being improved. Further, due to the range restrictions in the NFC communication, any potential hackers may be easily identified.

As described above in FIG. 2B, after generating the private key at step S226, the user device 240 may not transmit the private key to the NFC tag 280. Instead, the user device 240 may perform the authentication at step S232, remove the private key at step S230, and transmit the authentication to the external NFC tag 280 at step S236. In this case, the user device 240 and the target device 260 may be one integrated device.

Now referring to FIG. 2D, illustrated are steps for authentication according to further aspects of the present disclosure. In addition to the authorization key generation as illustrated in FIGS. 2B and 2C, a network device 290 is additionally included. Descriptions for steps S220-S226, S230, and S232 are the same as those described above with regard to FIGS. 2B and 2C and thus are omitted here.

After generating the private key at step S226, the user device 240 encrypts the private key, thereby adding an additional layer of security. The encryption may be performed with an encryption algorithm and the encrypted private key may be decrypted based on a decryption password.

At step S242, the user device 240 transmits the decryption password to the network device 290, which may be a server, a cloud server, or another computing device in a network. The network device 290 may employ a sufficient level of security to protect the decryption password. Only upon reception of a proper request after verification, the network device 290 may provide the decryption password.

At step S244, the user device 240 writes the encrypted private key to the external NFC tag 280. Since the private key is encrypted and written to the external NFC tag 280, the user device 240 does not have to hold it for the predetermined period. Thus, the private key is removed from the user device 240 right after the private key is encrypted and transferred to the external NFC tag 280 at step S230. In this example, the external NFC tag 280 keeps the encrypted private key as long as needed by the target device 260. Since the encrypted private key may not be decrypted without the decryption password, the encrypted key saved in the external NFC tag 280 does not have to be removed or deleted. Thus, the external NFC tag 280 may keep the encrypted private key until an update on the encrypted private key is performed.

The target device 260 reads the encrypted private key from the external NFC tag 280 at step S248, and may be able to detect the encryption of the private key. After the detection of encryption, the target device 260 may contact the network device 290 and provide a request for the decryption password. Upon reception of the request from the target device 260 and verification of the target device 260, the network device sends the corresponding decryption password to the target device 260 at step S246.

After receiving the decryption password, the user device decrypts the encrypted private key at step S250, and performs authentication at step S232 based on the decrypted private key. Since the private key is never transmitted among the NFC tag 220, the user device 240, the target device 260, the external NFC tag 280, and the network device 290, eavesdroppers in the network may be unable to obtain the private key, thereby the level of security being increased.

Now referring to FIG. 3, illustrated is a state machine 300 for generating a private key according to aspects of the present disclosure. This state machine 300 may be applicable to any aspects disclosed above in this disclosure. Based on a list of an order of or multiple entries of the passcode and scanning or tapping, one or more private keys may be generated based on the state machine 300. Differently put, a private key corresponding one list may be different from a private key corresponding to another list.

Generation of the private key may start with entry of the passcode at state 320 or scanning or tapping at state 340. For example, when the state 320 is selected first, the next state may be the state 320, the state 340, or the state 360, meaning any state can follow. Likewise, when the state 340 is selected first, any state can follow. It is possible that one state can be consecutively repeated according to the state machine 300. In this regard, the user device may display information requesting the user to enter a number of consecutive repetitions. For example, when the user enters the passcode, the user device displays a question asking how many time the passcode would be entered consecutively. When the user enters “5,” that means the passcode needs to be entered five times. Instead of manually entering the passcode five times consecutively, the user just needs to enter “5” in response to the question, thereby the user device automatically entering the passcode five time.

Likewise, when the motion needs to be performed consecutively, the user device may display information requesting the user to enter a number of consecutive repetitions. For example, when the user performs the motion, the user device displays a question asking how many time the motion would be consecutively performed. When the user enters “5,” that means the motion needs to be performed five times. Instead of manually performing the motion five times consecutively, the user just needs to enter “5” in response to the question, thereby the user device automatically performs the motion five time.

In an aspect, when the state 320 is selected consecutively or after the state 340, different user-selected passcodes may be entered at each time or the same passcode with user-selected different passcodes may be entered in a user's predetermined order.

In an aspect, the scanning and tapping of the user device have been performed on POS devices or any other devices. However, to enable multiple tapping or scanning, the user device may be scanned or tapped to a mobile device, which can communicate with the user device.

For example, a first list may include firstly an entry of the passcode, secondly scanning or tapping, and thirdly another entry of the passcode; a second list may include firstly scanning or tapping, and secondly an entry of the passcode; and a third list may include firstly an entry of the passcode, secondly scanning or tapping, thirdly scanning or tapping, and fourthly another entry of the passcode. The first private key corresponding to the first list, the second private key corresponding to the second list, and the third private key corresponding to the third list are different from each other. In other words, the user device, such as the user device 110 of FIG. 1 or the user device 240 of FIGS. 2A-2D, may be used for multiple purposes including credit card transactions, log in to a cryptocurrency/blockchain/bank/health/financial institution account, or access to private/sensitive information. In this example, each private key is used for one purpose.

In other examples, when multi-signature transactions or multi-party computation transactions are needed, multiple private keys may be needed. In this case, the user device may be able to generate the multiple private keys based on multiple lists of an order and one or more entries of the passcode and scanning or tapping. In this way, one user device is capable of generating multiple private keys.

Likewise for shamir secret sharing, one user device may be capable of generating a sufficient number of private keys to access a secret.

Since the user enters the same passcode and makes the same simple move (e.g., scanning or tapping) with the user device, multiple private keys can be made with case. Further, to generate an appropriate private key, the user has to enter the passcode and make the simple move according to a predetermined list of an order and one or more entries of the passcode and scanning or tapping. If either of the order or entries does not match the predetermined list, no private key may be generated or a different private key may be generated. Thereby, the level of security has been increased.

There is a completion or key generation button (not shown), actual or displayed, on the user device. In order to complete a combination, the user needs to push the completion button. After the completion or key generation button is pushed, the combination of the passcodes and the one or more motions is completed, and a corresponding private key may be generated.

In an alternative aspect, when a predetermined period has passed after a previous entry, the combination of one or more passcodes and one or more motions may be deemed complete, and the corresponding private key may be generated. The predetermined period may be less than one, two, or five seconds. For example, when the first combination is (key+tapping) and the second combination is (key+tapping+tapping), When there is no more entry after the predetermined period has passed after the first tapping, that completes the first combination. Or, the second tapping is entered before the predetermined period passes and no more entries are made after the predetermined period has passed after the second tapping, that completes the second combination.

Computing system functionality can be enhanced by a computing systems' ability to be interconnected to other computing devices via network connections. Network connections may include, but are not limited to, connections via wireless connections including satellite, Ethernet, cellular connections, or wired connections including even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), Blockchain as a Service (“BaaS”), and deployment models (e.g., private cloud, community cloud, public cloud, hybrid cloud, etc.).

Cloud and remote based service applications are prevalent. Such applications are hosted on public and private remote systems such as clouds and usually offer a plurality of web based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available. Examples of software user interfaces include graphical user interfaces, text command line based user interface, function key or hot key user interfaces, and the like.

Disclosed aspects may comprise or utilize a special purpose or general-purpose computer including computer hardware, as discussed in greater detail below. Disclosed aspects also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, aspects of the invention can comprise at least two distinctly different kinds of computer-readable media: physical computer-readable storage media and transmission computer-readable media. The transmission computer-readable media that carry computer-executable instructions may include signals, carrier waves, and propagating signals.

On the other hand, the physical computer-readable storage media may be volatile memory, which requires power to maintain stored information. The physical computer-readable storage media may be non-volatile memory, which retains stored information when the non-volatile memory is not powered. In some aspects, the non-volatile memory may include flash memory, dynamic random-access memory (DRAM), ferroelectric random-access memory (FRAM), or phase-change random access memory (PRAM). In some aspects, the computer-readable media may include, by way of non-limiting examples, CD-ROMs, DVDs, flash memory devices, magnetic disk drives, magnetic tapes drives, optical disk drives, and cloud computing-based storage. In some aspects, the computer-readable media may be a combination of devices such as those disclosed herein.

The physical computer-readable media may include executable instructions (e.g., codes, programs, algorithms, etc.). The executable instructions represent instructions that are executable by the processor. Further, the computer-readable media may exclude signals, carrier waves, and propagating signals.

Generally, a processor executes executable instructions stored in the computer-readable media. The processor may include, without limitation, Field-Programmable Gate Arrays (“FPGAs”), Program-Specific or Application-Specific Integrated Circuits (“ASICs”), Program-Specific Standard Products (“ASSPs”), System-On-A-Chip Systems (“SOCs”), Complex Programmable Logic Devices (“CPLDs”), Central Processing Units (“CPU”), Graphical Processing Units (“GPU”), or any other type of programmable hardware by performing the basic arithmetic, logical, control and input/output (I/O) operations specified by the instructions. As used herein, terms such as “executable module,” “executable component,” “component,” “module,” or “engine” may refer to the processor or to software objects, routines, or methods that may be executed by the processor. The different components, modules, engines, and services described herein may be implemented as objects, codes, programs, or libraries that the processor executes.

A general-purpose computer, special purpose computer, or special purpose processing device also includes a display, which may be a cathode ray tube (CRT), a liquid crystal display (LCD), light emitting diode (LED), or an organic light emitting diode (OLED) display. In some aspects, the OLED display is a passive-matrix OLED (PMOLED) or active-matrix OLED (AMOLED) display. In other aspects, the display may be a touch screen, through which alphanumerals may be input or entered. In still other aspects, the display may be a hologram, through which users may enter data by touching or swiping space.

Data or commands may be entered via an input device in the special purpose or general-purpose computer. The input device may be a keyboard, a mouse, a touch screen, or a hologram keyboard.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones tablets, mobile devices, smartphones, PDAs, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include FPGAs, ASICs, ASSPs, SOCs, CPLDs, etc.

### Example Implementations

In view of the foregoing, the present disclosure relates, for example and without being limited thereto, to the following aspects:

In a first aspect, A key generation device for generating a private key includes a near field communication (NFC) tag configured to store a first key and a user device. The user device includes an input device configured to receive a first passcode from a user, a display screen configured to display information, a processor, and a memory including instructions stored thereon. The instructions, when executed by the processor, cause the user device to read the first key from the NFC tag and perform a first key derivation function or a first hashing algorithm based on the first key and the first passcode from the user to generate a private key. The private key is used to complete an operation that the user has intended to perform.

In a second aspect of the key generation device as recited in the first aspect, the operation includes a transaction and the first private key is financial information to complete the transaction.

In a third aspect of the key generation device as recited in any of the preceding aspects, the operation includes a log in to a user's blockchain account and the first private key is paired with a public key for the user to access the user's blockchain account or approve a blockchain based token or data transactions.

In a fourth aspect of the key generation device as recited in any of the preceding aspects, the private key is a part of a plurality of private keys used for a shamir secret sharing algorithm, multi-signature transaction, or multi-party computation.

In a fifth aspect of the key generation device as recited in any of the preceding aspects, the first key is stored in the NFC tag with a password protection.

In a sixth aspect of the key generation device as recited in any of the preceding aspects, the private key is removed from the user device after a predetermined period.

In a seventh aspect of the key generation device as recited in any of the preceding aspects, the user device transmits the private key to an external NFC tag and removes the private key therefrom.

In an eighth aspect of the key generation device as recited in any of the preceding aspects, the private key is encrypted before the private key is transmitted to the external NFC tag.

In a ninth aspect of the key generation device as recited in any of the preceding aspects, the external NFC tag is used to complete the operation.

In a tenth aspect of the key generation device as recited in any of the preceding aspects, the private key has been generated by a second key derivation function or a second hashing algorithm based on a second passcode and an output of the first key derivation function or the first hashing algorithm.

In an eleventh aspect, a key generation system generates a plurality of private keys. The key generation device includes a near field communication (NFC) tag configured to store a first key and a user device. The user device includes an input device configured to receive a first passcode from a user, a display screen configured to display information, a processor, and a memory including instructions stored thereon. The instructions, when executed by the processor, cause the user device to read a first key from a near field communication (NFC) tag, perform a first key derivation function or a first hashing algorithm based on the first key and the passcode from the user to generate a first private key, receive a combination of an order of and a number of entries of one or more user-selected passcodes and a motion of bringing the NFC tag in proximity to the user device, and generate a plurality of second private keys based on combinations of an order of and a number of entries of the one or more user-selected passcodes and the motion. Each of the plurality of second private keys is to complete a respective operation that the user has intended to perform.

In a twelfth aspect of the key generation device as recited in the eleventh aspect, the motion is a tapping of the NFC tag to the user device or scanning of the NFC tag by the user device.

In a thirteenth aspect of the key generation device as recited in any of the preceding aspects from the eleventh aspect, an order of and a number of entries of the one or more user-selected passcodes and the motion for one second private key are different from an order of and a number of entries of the one or more user-selected passcodes and the motion for another second private key, which is different from the one second private key.

In a fourteenth aspect of the key generation device as recited in any of the preceding aspects from the eleventh aspect, when one user-selected passcode or the motion is needed for consecutive entries, the display displays information to request an entry of a numeral input from the user via the input device, thereby not requiring multiple entries of the one user-selected passcode or the motion.

In a fifteenth aspect of the key generation device as recited in any of the preceding aspects from the eleventh aspect, when a completion button, actual or displayed, in the user device is pushed, the combination is complete and a second private key corresponding to the combination is generated.

In a sixteenth aspect of the key generation device as recited in any of the preceding aspects from the eleventh aspect, the user device transmits the first private key to an external NFC tag and removes the first private key.

In a seventeenth aspect of the key generation device as recited in any of the preceding aspects from the eleventh aspect, the first private key is encrypted before the first private key is transmitted to the external NFC tag.

In an eighteenth aspect of the key generation device as recited in any of the preceding aspects from the eleventh aspect, the external NFC tag is used to complete the operation.

In a nineteenth aspect of the key generation device as recited in any of the preceding aspects from the eleventh aspect, the first private key has been generated by a second key derivation function or a second hashing algorithm based on a third passcode and an output of the first key derivation function or the first hashing algorithm.

In a twentieth aspect, a non-transitory computer-readable medium including instructions stored thereon that, when executed by a computer, cause the computer to perform a method for generating a plurality of private keys. The method includes reading a first key from a near field communication (NFC) tag, performing a first key derivation function or a first hashing algorithm based on the first key and the passcode from the user to generate a first private key, receiving a combination of an order of and a number of entries of one or more user-selected passcodes and a motion of bringing the NFC tag in proximity to the user device, and generating a plurality of second private keys based on combinations. Each of the plurality of second private keys is to complete a respective operation that the user has intended to perform.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A key generation device comprising:
a near field communication (NFC) tag configured to store a first key; and
a user device comprising:
an input device configured to receive a first passcode from a user;
a display screen configured to display information;
a processor; and
a memory including instructions stored thereon that, when executed by the processor, cause the user device to:
read the first key from the NFC tag; and
perform a first key derivation function or a first hashing algorithm based on the first key and the first passcode from the user to generate a private key;
wherein the private key is used to complete an operation that the user has intended to perform.

2. The key generation device according to claim 1, wherein the operation includes a transaction and the first private key is financial information to complete the transaction.

3. The key generation device according to claim 1, wherein the operation includes a log in to a user's blockchain account and the first private key is paired with a public key for the user to access the user's blockchain account, or approve a blockchain based token or data transaction.

4. The key generation device according to claim 1, wherein the private key is a part of a plurality of private keys used for a shamir secret sharing algorithm, multi-signature transaction, or multi-party computation.

5. The key generation device according to claim 1, wherein the first key is stored in the NFC tag with a password protection.

6. The key generation device according to claim 1, wherein the private key is removed from the user device after a predetermined period.

7. The key generation device according to claim 1, wherein the user device transmits the private key to an external NFC tag and removes the private key therefrom.

8. The key generation device according to claim 7, wherein the private key is encrypted before the private key is transmitted to the external NFC tag.

9. The key generation device according to claim 7, wherein the external NFC tag is used to complete the operation.

10. The key generation device according to claim 1, wherein the private key has been generated by a second key derivation function or a second hashing algorithm based on a second passcode and an output of the first key derivation function or the first hashing algorithm.

11. A key generation system comprising:
a near field communication (NFC) tag configured to store a first key; and
a user device comprising:
an input device configured to receive a first passcode from a user;
a display screen configured to display information;
a processor; and
a memory including instructions stored thereon that, when executed by the processor, cause the user device to:
read a first key from a near field communication (NFC) tag;
perform a first key derivation function or a first hashing algorithm based on the first key and the passcode from the user to generate a first private key;
receive a combination of an order of and a number of entries of one or more user-selected passcodes and a motion of bringing the NFC tag in proximity to the user device; and
generate a plurality of second private keys based on combinations of an order of and a number of entries of the one or more user-selected passcodes and the motion,
wherein each of the plurality of second private keys is to complete a respective operation that the user has intended to perform.

12. The key generation system according to claim 11, wherein the motion is a tapping of the NFC tag to the user device or scanning of the NFC tag by the user device.

13. The key generation system according to claim 11, wherein an order of and a number of entries of the one or more user-selected passcodes and the motion for one second private key are different from an order of and a number of entries of the one or more user-selected passcodes and the motion for another second private key, which is different from the one second private key.

14. The key generation system according to claim 11, wherein, when one user-selected passcode or the motion is needed for consecutive entries, the display displays information to request an entry of a numeral input from the user via the input device, thereby not requiring multiple entries of the one user-selected passcode or the motion (this should also include the motion of the user device/NFC).

15. The key generation system according to claim 11, wherein, when a completion button, actual or displayed, in the user device is pushed, the combination is complete and a second private key corresponding to the combination is generated.

16. The key generation system according to claim 11, wherein the user device transmits the first private key to an external NFC tag and removes the first private key.

17. The key generation system according to claim 16, wherein the first private key is encrypted before the first private key is transmitted to the external NFC tag.

18. The key generation system according to claim 16, wherein the external NFC tag is used to complete the operation.

19. The key generation system according to claim 16, wherein the first private key has been generated by a second key derivation function or a second hashing algorithm based on a third passcode and an output of the first key derivation function or the first hashing algorithm.

20. A non-transitory readable medium including instructions stored thereon that, when executed by a computing device, cause the computing device to perform a method comprising:
reading a first key from a near field communication (NFC) tag;
performing a first key derivation function or a first hashing algorithm based on the first key and the passcode from the user to generate a first private key;
receiving a combination of an order of and a number of entries of one or more user-selected passcodes and a motion of bringing the NFC tag in proximity to the user device; and
generating a plurality of second private keys based on combinations,
wherein each of the plurality of second private keys is to complete a respective operation that the user has intended to perform.
